(19) United States
(12) Patent Application Publication
(10) Pub. No.: US 2022/0165535 A1
(43) Pub. Date: May 26, 2022

(54) MAGNETRON

(71) Applicant: Teledyne UK Limited, Chelmsford (GB)

(72) Inventors: Robert Charles Wilson, Maldon (GB); Daniel James Clay, Laindon (GB)

(21) Appl. No.: 17/455,772

(22) Filed: Nov. 19, 2021

(30) Foreign Application Priority Data
Nov. 26, 2020 (GB) 2018625.0

(51) Int. Cl. H01J 23/22; H01J 23/20; H01J 23/02

(52) U.S. Cl. CPC H01J 23/22; H01J 23/02; H01J 23/20

(57) ABSTRACT

There is provided herein an anode for a magnetron, the anode comprising: a cylindrical shell defining a longitudinal axis, a centre of the shell for accommodating a cathode of the magnetron; a plurality of vanes arranged at angular intervals around the shell, wherein an angular separation between each vane and its adjacent vane is configured to provide a cavity resonator of the magnetron, wherein each vane has a width extending radially inwardly from the shell toward the centre of the shell, and has a length continuously extending longitudinally in parallel with the longitudinal axis of the shell; and a plurality of annular strap rings for setting a resonant mode spectrum of the cavity resonator, wherein the strap rings are arranged at longitudinal intervals and concentrically with the longitudinal axis of the shell, wherein each vane comprises an inner vane segment arranged to face the cathode and a respective outer vane segment connected to the inner vane segment and interposed between the inner vane segment and the shell, and wherein the plurality of vanes are configured to support the plurality of strap rings between the respective inner and outer vane segments such that each vane couples alternate strap rings and each strap ring couples alternate vanes.

### FIELD OF THE INVENTION

The present disclosure relates to an anode for a magnetron, a vane thereof, a magnetron, and methods of manufacturing an anode. The apparatus and methods may find particular application but not exclusively in the field of the generation of microwaves, for example, for use in a particle accelerator.

### BACKGROUND

A magnetron may be used to generate radio frequency (RF) energy (such as microwaves) for a variety of different purposes. For example, RF energy generated by a magnetron may be provided to a particle accelerator (such as a linear accelerator) and used to establish accelerating electromagnetic fields for the acceleration of charged particles, such as electrons. In some applications accelerated electrons may be directed to be incident on a target material (such as tungsten), which causes some of the energy of the electrons to be emitted as x-rays from the target material.

Generated X-rays may, in some applications, be used for medical imaging and/or treatment purposes. For example, x-rays may be directed to be incident on all or part of a patient's body and one or more sensors may be positioned to detect x-rays which are transmitted and/or reflected by the patient's body. Detected x-rays may be used to form an image of all or part of a patient's body which may be capable of resolving details of the internal structure of the body. X-rays may additionally or alternatively be directed to be incident on a particular part of a patient's body for treatment purposes. For example, x-rays may be directed to be incident on a tumour detected in the body in order to treat the tumour by destroying cancerous cells in the tumour.

Alternatively, accelerated electrons may be directed to be incident on a particular part of a patient's body (such as a tumour) for treatment purposes. For example, electrons output from a particle accelerator (such as a linear accelerator) may be collimated and directed to be incident on part of a patient's body.

In further applications a particle accelerator may be used to generate x-rays for non-medical purposes. For example, generated x-rays may be directed to be incident on a non-medical target to be imaged. One or more sensors may be positioned to detect x-rays which are transmitted by and/or reflected from the imaging target. The detected x-rays may be used to form an image capable of resolving the internal structure of the imaging target. X-ray imaging may find particular use in security related applications, since it is capable of resolving items which are otherwise concealed from view. For example, x-ray imaging may be used to image cargo from outside of a container in which the cargo is stored. X-ray images may be capable of resolving different objects which form part of the concealed cargo in order to identify the contents of the cargo.

Several applications of a magnetron have been described above in which generated RF energy is used to accelerate charged particles, such as electrons. However, magnetrons may find other applications such as for the generation of RF energy for use in radars.

It is in this context that the present disclosure has been devised.

### BRIEF SUMMARY OF THE DISCLOSURE

In accordance with a first aspect of the present disclosure, there is provided an anode for a magnetron, the anode comprising: a cylindrical shell defining a longitudinal axis, a centre of the shell for accommodating a cathode of the magnetron; a plurality of vanes arranged at angular intervals around the shell, wherein an angular separation between each vane and its adjacent vane is configured to provide a cavity resonator of the magnetron, wherein each vane has a width extending radially inwardly from the shell toward the centre of the shell, and has a length continuously extending longitudinally in parallel with the longitudinal axis of the shell; and a plurality of annular strap rings for setting a resonant mode spectrum of the cavity resonator, wherein the strap rings are arranged at longitudinal intervals and concentrically with the longitudinal axis of the shell, wherein each vane comprises an inner vane segment arranged to face the cathode and a respective outer vane segment connected to the inner vane segment and interposed between the inner vane segment and the shell, and wherein the plurality of vanes are configured to support the plurality of strap rings between the respective inner and outer vane segments such that each vane couples alternate strap rings and each strap ring couples alternate vanes.

In the anode described herein, each vane is provided in two parts: an inner vane segment and its respective outer vane segment, whereby the straps rings are arranged therebetween. In doing so, the strap rings pass through the vanes, so as to be enclosed by the vanes and are only exposed in the resonant cavities. This improves the stability of a magnetron that includes the above described anode, as compared with magnetrons having strap rings that are exposed at either end of anode vanes. Furthermore, not only are the strap rings sufficiently and stably supported by the respective vanes by being arranged between the respective inner and outer vane segments, the anode described herein is provided with more flexibility in the design of the straps and their arrangement with respect to the vanes. This means that the mode separation and RF field distribution trade off can be met more easily by a suitable strap design, as compared with magnetrons of the prior art. Moreover, the anode described herein facilitates further magnetron performance improvement. This is because the part of the vane facing the cathode offers a solid and continuous profile. By providing such a continuous profile, no gaps are provided along the vane, thus leading to lower RF losses and a smoother RF field distribution as compared with the prior art. Such a continuous profile without any gaps may therefore increase the power output.

Each alternate vane may be arranged to support the same strap ring, so as to be electrically connected by the same strap ring.

The inner vane segments may be integrally formed. The outer vane segments may be integrally formed. The length of each vane may be equal to the length of the resonant cavity. In doing so, the inner and outer vane segments may be formed with continuous profiles, thereby improving power output by a magnetron in operation.

The plurality of vanes may include a plurality of holes defined through a depth of the vanes, the holes for the strap rings to pass therethrough, wherein the plurality of holes may include first holes and second holes, wherein the first holes may be for the vanes to couple with strap rings passing therethrough, wherein each first hole may have a cross-sectional area dimensioned to a cross-sectional area of the respective strap ring passing therethrough, wherein the second holes may be dimensioned to be bigger than the cross-sectional area of a strap ring passing through the second hole, such that, in use, the respective vane may not be configured to couple with the strap ring arranged in the second hole, wherein the plurality of vanes may include angularly alternating first vanes and second vanes, wherein each first vane may include a plurality of the first holes and the second holes that alternate longitudinally along the length of each first vane, as defined by a first groove pattern in a longitudinal surface of at least one of the inner vane segment and outer vane segment that faces its respective vane segment, wherein the first groove pattern of each first vane may be angularly aligned with the first groove pattern of the other first vanes, wherein each second vane may include a plurality of the first holes and the second holes that alternate longitudinally along the length of each second vane, as defined by a second groove pattern in a longitudinal surface of at least one of the inner vane segment and outer vane segment that faces its respective vane segment, wherein the second groove pattern of each second vane may be angularly aligned with the second groove pattern of the other second vanes, and wherein the first holes of the second vanes may be angularly aligned with the second holes of the first vanes, and wherein the first holes of the first vanes may be angularly aligned with the second holes of the second vanes. Accordingly, the strap rings couple with the respective vanes by virtue of electrical contact when passing through the first holes, whilst not coupling with the other vanes by passing through the second holes without contact, thereby connecting alternately arranged vanes compactly and efficiently.

The first groove pattern may be formed on only one of an inner vane segment and an outer vane segment. For example, a first groove pattern may be formed on an inner vane segment and the corresponding longitudinal surface of the outer vane segment may comprise a substantially flat surface of vice versa.

The groove pattern of each inner vane segment may be symmetrical with the groove pattern of its respective outer vane segment. Accordingly, the strap rings may be equally supported by the inner and outer vane segments.

Each of the first and second groove patterns may include alternating grooves and protrusions forming a castellated profile in at least one vane segment, wherein each protrusion may define a recess that is smaller than the groove, wherein the grooves of the groove pattern may define at least half the cross-sectional profile of the second holes and the recesses of the protrusions may define at least half the cross-sectional profile of the first holes. In other examples, the protrusions may not include a recess but may be formed of a substantially flat longitudinal surface for contacting a strap ring. In such examples, a strap ring may be brazed to a substantially flat surface on an inner vane segment and/or an outer vane segment. The first holes may be formed at least partially by a substantially flat longitudinal surface on an inner vane segment and/or an outer vane segment. The substantially flat surface may form a longitudinal surface of a protrusion forming part of a groove pattern.

Each inner vane segment may have another longitudinal surface opposite the longitudinal surface defined by one of the first and second groove patterns, wherein the another longitudinal surface may be flat having a smooth profile. This advantageously means that there are no gaps down the length of the inner vane segments that face the cathode, thereby offering improved electrical properties.

Each outer vane segment may have another longitudinal surface opposite the longitudinal surface defined by one of the first and second groove patterns, wherein the another longitudinal surface may be attached to an inner surface of the shell. The another longitudinal surface of each outer vane segment may be flat having a smooth profile. Providing the outer vane segments with smooth profiles may improve the efficiency of manufacture, since the outer vane segments may be efficiently connected to the shell.

The inner surface of the shell may include a plurality of grooves extending longitudinally down the length of the shell and arranged angularly at intervals, each groove being dimensioned to seat a respective outer vane segment. This may improve manufacture, since the grooves defined in the inner wall of the shell may provide an indication of where the outer vane segments should be placed, when assembling the anode.

The inner surface of the shell may have a smooth profile. This may reduce the number of steps of manufacture, thereby improving efficiency and cost-effectiveness thereof.

A gap may be provided between the inner and outer vane segments. The inner and outer vane segments may not be in direct contact with one another. That is, once the anode is assembled, the inner and outer vane segments may be arranged such that they are not in direct contact with one another. Electrical and/or mechanical connection between the inner and outer vane segments may be provided through direct contact between both the inner and outer vane segments and their respective annular strap rings. For example, each respective inner and outer vane segment may both be in direct contact with each alternate annular strap ring.

Providing a physical gap between respective and inner and outer vane segments ensures that a well-defined connection is provided between the vane segments and the annular strap rings. This ensures that suitable electrical connection is provided between the vane segments and the strap rings. Such an arrangement may ensure that the resonant modes supported by the anode are as desired. If suitable electrical connection is not provided between the vane segments and the strap rings then the spectrum of resonant modes supported by the anode may be compromised. For example, in arrangements in which the inner and outer vane segments are placed in direct contact with each other (as opposed to providing a gap between the inner and outer vane segments), then very tight geometrical tolerances may be required to ensure that suitable electrical connection is achieved between the vane segments and the strap rings. Such an arrangement may be difficult to achieve in practice and the practical limitations of this arrangement may compromise the resonant mode spectrum supported by the anode. Providing inner and outer vane segments which are not in direct contact with each other and providing direct electrical connection between the vane segments and the strap rings may therefore simplify the mechanical arrangement of the anode and ensure suitable electrical connection between all components of the anode.

The anode may further comprise at least one tag for connecting each inner vane segment to its respective outer vane segment. The at least one tag may be arranged at a longitudinal end of the respective vane. The tags may provide electrical and/or mechanical connection between respective inner and outer vane segments. For example, each respective inner and outer vane segment may not be in direct physical contact with each other and may be arranged with a gap between them. At least one tag may be arranged to be in physical contact with both an inner vane segment and its respective outer vane segment so as to provide mechanical and/or physical connection between the respective inner and outer vane segment. In at least some examples, a respective inner and outer vane segment may be provided with a tag connecting the vane segments together at each of their longitudinal ends (such that each outer vane segment is connected to its respective outer vane segment via at least two tags). The tags efficiently connect the vane segments together at low-cost. As was described above, additional or alternative mechanical and/or electrical connection between inner and outer vane segments may be provided by virtue of physical contact with respective annular strap rings.

Providing vane tags to electrically connect the inner and outer vane segments at the longitudinal ends of the vane segments, may ensure correct operation of the magnetron. In arrangements in which the inner and outer vane segments are not in direct contact with each other, there may be a discontinuity between the inner and outer vane segments at their longitudinal ends. Such a discontinuity may lead to a complex physical path for RF currents to follow and may alter the distribution of resonant frequencies supported by the anode. A suitable arrangement of vane tags may avoid such a discontinuity by providing electrical connection between the vane segments at their longitudinal ends.

The inner and outer vane segments may be formed of the same material. The vanes may therefore be formed efficiently.

According to a second aspect of the disclosure, there is provided a vane for an anode of a magnetron, the vane as described herein.

According to a third aspect of the disclosure, there is provided a magnetron comprising an anode as described herein.

According to a fourth aspect of the disclosure, there is provided a method of manufacturing an anode for a magnetron, the method comprising: providing a cylindrical shell defining a longitudinal axis, a centre of the shell for accommodating a cathode of the magnetron; providing a plurality of vanes, wherein each vane has a width for extending radially inwardly from the shell toward the centre of the shell, and has a length for continuously extending longitudinally in parallel with the longitudinal axis of the shell; providing a plurality of annular strap rings for setting a resonant mode spectrum of a cavity resonator of the magnetron; and arranging the vanes and strap rings in the shell, such that: the vanes are arranged at angular intervals around the shell, wherein an angular separation between each vane and its adjacent vane is for providing the cavity resonator of the magnetron, the strap rings are arranged at longitudinal intervals and concentrically with the longitudinal axis of the shell, wherein each vane comprises an inner vane segment arranged to face the cathode and a respective outer vane segment connected to the inner vane segment and interposed between the inner vane segment and the shell, and wherein the plurality of vanes are configured to support the plurality of strap rings between the respective inner and outer vane segments such that each vane couples alternate strap rings and each strap ring couples alternate vanes.

The providing the plurality of vanes may comprise forming the plurality of vanes by: forming a first hole pattern in a first group of metal cuboids through a depth thereof, wherein the first hole pattern includes a plurality of first holes and second holes alternating along the length of each metal cuboid in the first group, wherein each first hole has a cross-sectional area dimensioned to the cross-sectional area of a strap ring for a magnetron, and wherein each second hole has a cross-sectional area dimensioned to be greater than the cross-sectional area of the strap ring, such that the strap ring can pass through the second hole without contacting the metal block; forming a second hole pattern in a second group of metal cuboids through a depth thereof, wherein the second hole pattern includes a plurality of the first holes and the second holes alternating along the length of each metal cuboid in the second group, wherein when the first group and the second group of the milled cuboids are angularly arranged around the shell, the first holes of the first group are aligned with the second holes of the second group, and the second holes of the first group are aligned with the first holes of the second group; and cutting each metal cuboid lengthways into two elongate segments to provide a vane including an inner vane segment and a respective outer vane segment, the cutting being through the first and second holes to define a groove pattern on a longitudinal surface of at least one of the inner vane segment and the outer vane segment, wherein the plurality of vanes is arranged around the shell such that: the vanes of the first group alternate with the vanes of the second group, the first and second holes are angularly aligned for each alternate vane segment, the first holes of the first group are angularly aligned with the second holes of the second group, and the second holes of the first group are angularly aligned with the first holes of the second group. Accordingly, the method may be used to efficiently and cost-effectively manufacture the anode, since the inner and outer vane segments are formed from the same block, and thus have the matching profiles for providing the respective first and second holes. Furthermore, since the inner vane segments are integrally formed, and the outer vane segments are integrally formed, this gives rise to a continuous smooth profile along the vane segments of the anode, thereby providing a smoother path for the RF current to further improve the performance of a magnetron including the anode described herein.

The method may further comprise arranging the strap rings between the inner and outer vane segments in respective first holes for electrically connecting alternate vanes.

The method may further comprise providing a gap between the inner and outer vane segments. The inner and outer vane segments may be arranged such that they are not be in direct contact with one another. Electrical and/or mechanical connection between the inner and outer vane segments may be provided through direct contact between both the inner and outer vane segments and respective annular strap rings. For example, each respective inner and outer vane segment may both be in direct contact with each alternate annular strap ring.

The method may further comprise electrically connecting each outer vane segment to its respective inner vane segment. The electrically connecting may be performed using at least one tag arranged to contact both an inner and outer vane segment (thereby bridging the gap between the inner and outer vane segments). The at least one tag may be arranged substantially at a longitudinal end of a vane. The tags may provide electrical and/or mechanical connection between respective inner and outer vane segments. For example, each respective inner and outer vane segment may not be in direct physical contact with each other and may be arranged with a gap between them. At least one tag may be arranged to be in physical contact with both an inner vane segment and its respective outer vane segment so as to provide mechanical and/or physical connection between the respective inner and outer vane segment. In at least some examples, a respective inner and outer vane segment may be provided with a tag connecting the vane segments together at each of their longitudinal ends (such that each outer vane segment is connected to its respective outer vane segment via at least two tags). Tags may advantageously electrically connect the inner and outer vane segments efficiently at low cost.

The providing the shell may comprise providing a metallic cylinder and forming an even number of elongate grooves in an inner wall of the cylinder at angular intervals for seating the outer vanes. The providing the shell may comprise providing a metallic cylinder and smoothing an inner wall of the cylinder. The method may further comprise brazing the arranged strap rings and vanes together. The method may further comprise brazing the vanes to the inner wall of the shell.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention are shown schematically, by way of example only, in the accompanying drawings, in which:

FIG. 1A is a schematic illustration of a magnetron of a type contemplated herein;

FIG. 1B is a schematic illustration of a cross-section taken through the magnetron illustrated in FIG. 1A;

FIG. 2 is a perspective and exploded illustration of an anode according to a first example of the disclosure;

FIG. 3A is a schematic illustration of a magnetron according to the first example of the disclosure;

FIG. 3B is a schematic illustration of the cross-section A-A′ taken through the magnetron illustrated in FIG. 3A;

FIG. 3C is a schematic illustration of the cross-section B-B′ taken through the magnetron illustrated in FIG. 3A;

FIG. 4 is a flow chart of a method according to the first example of the disclosure;

FIG. 5A is a schematic illustration of assembling the anode according to the first example of the disclosure; and

FIG. 5B is a schematic illustration of an assembled anode according to the first example of the disclosure.

Throughout the description and the drawings, like reference numerals refer to like parts.

### DETAILED DESCRIPTION

Before particular examples of the present invention are described, it is to be understood that the present disclosure is not limited to the particular embodiments described herein. It is also to be understood that the terminology used herein is used for describing particular examples only and is not intended to limit the scope of the claims.

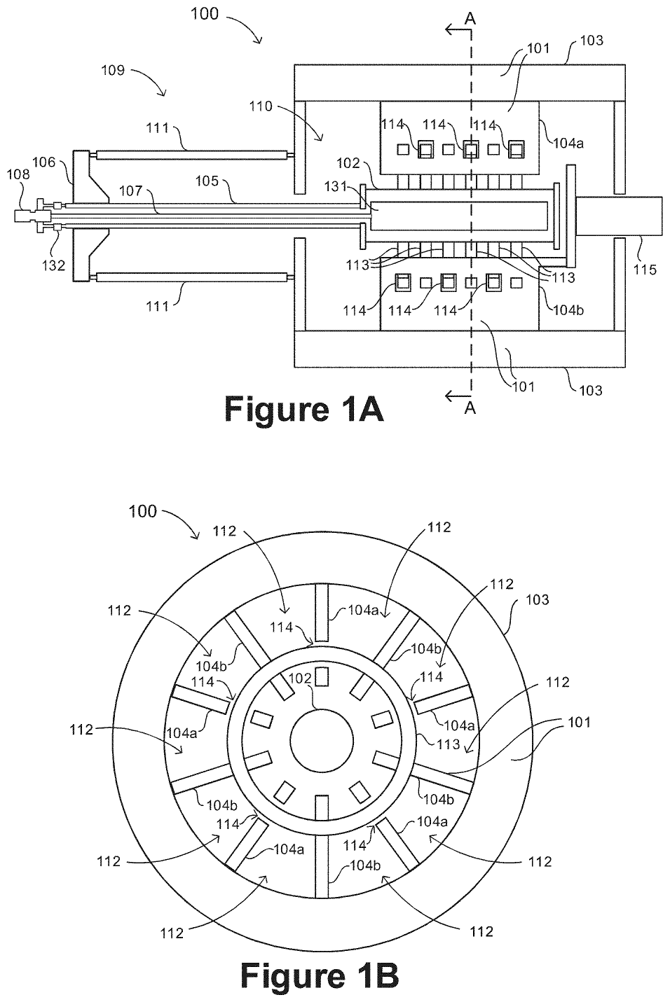

FIGS. 1A and 1B are schematic illustrations of an example magnetron 100 of a type contemplated herein. FIG. 1A shows a longitudinal cut-plane through the magnetron 100 and FIG. 1B shows a cross-section through the magnetron 100 taken at the plane A-A indicated in FIG. 1A.

The magnetron 100 includes an anode 101 and a cathode 102. The example anode 101 shown in FIGS. 1A and 1B includes a generally cylindrical anode wall 103 (also referred to as a shell) and a plurality of anode vanes 104 extending inwards from the anode wall 103. The shell 103 defines a longitudinal axis (left to right in FIG. 1A and out of the page in FIG. 1B) around which it surrounds. As will be described in further detail below, the anode vanes may comprise a first group of anode vanes 104a and a second group of anode vanes 104b.

The cathode 102 is situated at least partially inside the anode 101 and is held in position relative to the anode 101 including the anode vanes 104. The cathode 102 is supported and held in position relative to the anode 102 by a support arm 105. The support arm 105 is fixed in place at an end distal the cathode 102 by a support structure 106 so as to form a cantilever supporting the cathode 102.

The cathode 102 and at least an internal portion of the anode 101 (e.g. the volume inside the anode wall 103) are located inside a vacuum envelope 110. Similarly to other vacuum electron devices, in order to generate RF energy, the volume inside the vacuum envelope 110 is pumped to vacuum pressure conditions.

In addition to supporting the cathode 102 and holding the cathode 102 in position relative to the anode 101, the support arm may also provide electrical connection to the cathode 102 and a heater 131, which is generally included in the cathode 102. In the depicted example, an electrical connection may be established through the support arm 105 (e.g. an external casing forming the support arm 105) and to the cathode 102. The support arm 105 may be electrically connected to the support structure 106. The support structure 106 comprises electrically conductive material (e.g. copper) electrically coupled to the support arm 105 and may serve as a connection terminal for establishing electrical connection to the cathode 102. In the depicted example, the support arm 105 further includes an electrical connection 107 (which may extend internally along the support arm 105 as shown in FIG. 1A) extending between the heater 131 and a connection terminal 108. The heater 131 may, for example, comprise a filament and may be configured to heat the cathode 102 (e.g. to promote thermionic emission of electrodes from the cathode 102). The connection terminal 108 is electrically isolated from the casing of the support arm 105 and the support structure 106 by an electrically insulating member 132.

The connection terminal 108 and/or the support structure 106 may be arranged for connection to a power supply (not shown) such as a DC power supply (which may, for example, comprise a pulsed DC power supply), in order to provide electrical connection between the power supply and the cathode 102 and/or the heater 131. In practice, the cathode 102 may be held at a voltage of several kilovolts (with respect to the anode 101). For example, the support structure 106 may be electrically connected to an external power supply (not shown) in order to establish a voltage (through the support structure 106 and the support arm 105) between the cathode 102 and the anode 101.

The heater 131 may comprise a resistive element through which an electric current is passed in order to generate resistive heating. In such examples, the heater 131 may comprise two electrical terminals between which a heating current flows. The first terminal may be the connection terminal 108 and the second terminal may be a connection between the heater 131 and the cathode 102 (connection not shown). The connection terminal 108 may be held at a potential difference (of, for example, several volts) with respect to the cathode 102 in order to promote a heater current to flow through the heater 131.

The support arm 105 extends along a section 109 of the magnetron which may be referred to as a side arm 109. In the depicted example, the side arm 109 forms part of the vacuum envelope 110 and thus the internal volume of the side arm 109 may be pumped to vacuum pressure conditions. In the depicted example, the external structure of the side arm 109 is defined by the support structure 106 and a casing 111 extending between the support structure 106 and the anode 101. The casing 111 may be formed of an electrically insulating or dielectric material such as a ceramic.

The side arm 109 may function to provide a hold off distance between the anode 101 and a connection terminal 108 and the support structure 106 located substantially at an end of the side arm 109 distal the cathode 102 and the anode 101. Since the support structure 106 may be used to establish a voltage difference between the anode 101 and the cathode 102 there may a relatively high voltage between the support structure 106 and the anode 101 and/or other components of the magnetron. For example, during operation, the anode 101 may be electrically grounded and the cathode 102, via the support structure 106, may be held at a high voltage. For example, a voltage difference of several kilovolts (e.g. a voltage difference of 3 kV or more) may be provided between the cathode 102 and the anode 101. Due to the relatively high voltages used, components of the magnetron may be arranged to reduce a risk of electrical breakdown and arcing between components.

Voltage hold-off requirements in air are generally much more stringent than those in vacuum pressure conditions (e.g. by a factor of approximately eight). Suitable voltage hold-off between, for example, the anode 101 and the support structure 106 through air may be achieved through design of the casing 111 (which may comprise a dielectric material). For example, the shape and length of the casing 111 may be designed to reduce the risk of particle tracking along the casing 111 (which may lead to electrical breakdown between the support structure 106 and the anode 101). It may be possible to provide complex casing 111 shapes which can be used to reduce the length of the side arm 109 whilst maintaining suitable voltage hold-off. However, these may be complex and/or expensive and a simple cylindrical (or other simple shape) casing 111 may be used. In general, for a given shaped casing 111, there may be a minimum length of the side arm 109 which is needed in order to provide sufficient voltage hold-off between the support structure 106 and the anode 101.

The magnetron 100 further includes an output 115 for coupling RF energy generated during operation of the magnetron 100 out of the magnetron 100. The output 115 may comprise any suitable structure for coupling the magnetron 100 to one or more components (not shown) external to the magnetron 100 (such as a particle accelerator) for providing RF energy to the one or more external components. Whilst not shown in the Figures, the magnetron 100 may further comprise an output window through which the generated RF energy is output whilst isolating the vacuum envelope 110 from the external environment.

As was mentioned above, during operation of the magnetron 100, a voltage (which may be a high voltage, for example of several kilovolts) may be applied between the anode 101 and the cathode 102. In particular examples contemplated herein the anode 101 may be electrically grounded and the cathode 102 may be held at a high voltage with respect to the grounded anode 101.

The cathode 102 is configured to emit electrons, for example (but not necessarily), by thermionic emission which are drawn towards the anode by virtue of the voltage maintained between the cathode 102 and the anode 101. As was mentioned above, the cathode 102 may be heated in order to promote thermionic emission of electrons from the cathode 102. The emission properties of the cathode 102 may be driven by the temperature and the material properties of the emitting surface of the cathode 102.

As shown in FIG. 1B, the anode 101 includes a plurality of anode vanes 104 which define an even number of cavities 112 therebetween. Whilst not shown in the Figures, the magnetron 100 is subjected to a magnetic field running substantially parallel with the magnetron axis (left-to-right in FIG. 1A and into and out of the page in FIG. 1B). The magnetron axis may coincide with the longitudinal axis of the shell 103. The magnetic field may be generated by any suitable arrangement of one or more permanent magnets and/or electromagnets.

An electron cloud emitted from the cathode 102 is subject to both the electric field established between the anode 101 and the cathode 102 (by virtue of the voltage between them) and the magnetic field established in the magnetron. The combined effect of these fields is to cause a rotation of electrons around an interaction region between the anode 101 and the cathode 102. The rotation of the electron cloud past the cavities 112 induces an RF electromagnetic field which serves to excite resonant modes of the cavities 112. By inducing the RF field, the electron cloud may excite resonant modes of the cavity resonators based on the angular velocity of the electrons. This in turn may cause electrons to accelerate or decelerate due to the RF field at the anode 101, depending on the relative phase. As the electrons move across the vanes 104, a positive feedback effect may be created whereby the resonant-modes increase in energy. In practice, this may deform the electron cloud to undergo a spoked wheel effect (or space-charge wheel).

Interaction between the electron cloud and the anode 101 can occur through any of the resonant-modes supported by the anode 101. In practice, the most effective mode for producing useful RF power in a magnetron is referred to as a π-mode, in which the oscillations in each cavity 112 of the anode 101 are substantially 180° (π radians) out of phase with the oscillations in each immediately adjacent cavity 112. That is, in the π-mode each alternate cavity 112 in the magnetron oscillates substantially in phase with each other.

In some magnetrons, the separation between the π-mode frequency and the frequency of other resonant modes is too small to ensure stable operation of the magnetron. In order to separate the π-mode frequency from other resonant modes, a technique referred to as anode strapping may be used. In the magnetron depicted in FIGS. 1A and 1B the anode includes a plurality of anode straps/strap rings 113 extending around the anode 101 and between the anode vanes 104. As can be seen, for example, from FIG. 1B, each anode strap 113 is in electrical contact with each alternate anode vane 104 and passes through a suitably arranged aperture 114 in every other anode vane 104. For example, in the cross-section shown in FIG. 1B, the anode strap 113 passes through apertures 114 positioned in a first group of anode vanes 104a and is in electrical contact with each of a second group of anode vanes 104b. As can be seen in FIG. 1A other anode straps 103 are arranged to be in electrical contact with each of the first group of anode vanes 104a and to pass through apertures 114 located in the second group of anode vanes 104b. The vanes 104 thus support the anode straps/strap rings 113 such that each vane couples alternate straps 113 and each strap couples alternate vanes. By electrically connecting alternate anode vanes 104, the π-mode frequency may be separated from the frequency of other resonant modes.

The inventors have realised a number of problems in magnetrons of the prior art, particularly in magnetrons of the prior art that include vanes with distributed strapping, including straps arranged to be exposed at either end of the anode vanes. Such anodes may be formed by assembling a series of discs formed of one strap ring having protrusions therefrom to form the vanes. The discs may then be stacked together in the longitudinal direction so as to form the distributed strap anode.

The inventors have however realised that producing the anode in this way can cause two straps to be exposed at the ends of the vanes, once the anode has been assembled, thereby risking unstable magnetron operation. Furthermore, forming the anodes by stacking discs in the manner of the prior art can lead to costly manufacture, since the individual discs must be produced with very precise dimensions in order to fit together accurately to produce the desired effect. Moreover, during assembly of the anode, gaps are provided along the vanes between different discs that are stacked together. The inventors have realised that when the anode is brazed together, the brazing material between the gaps can lead to RF field losses along the vane, particularly along the longitudinal direction that faces the cathode, thereby reducing the power output, particularly for high energy magnetrons.

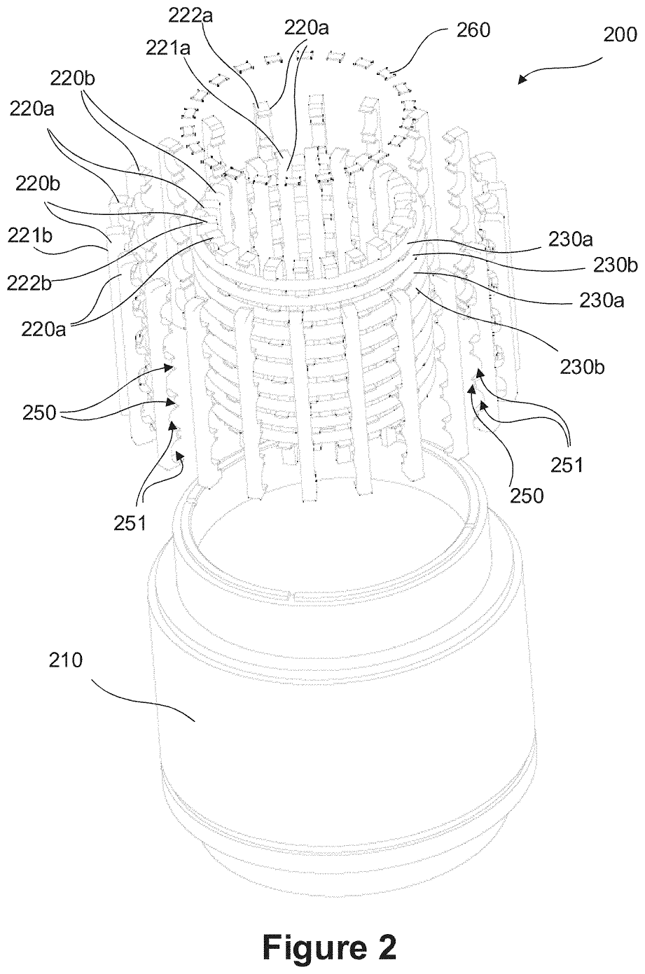

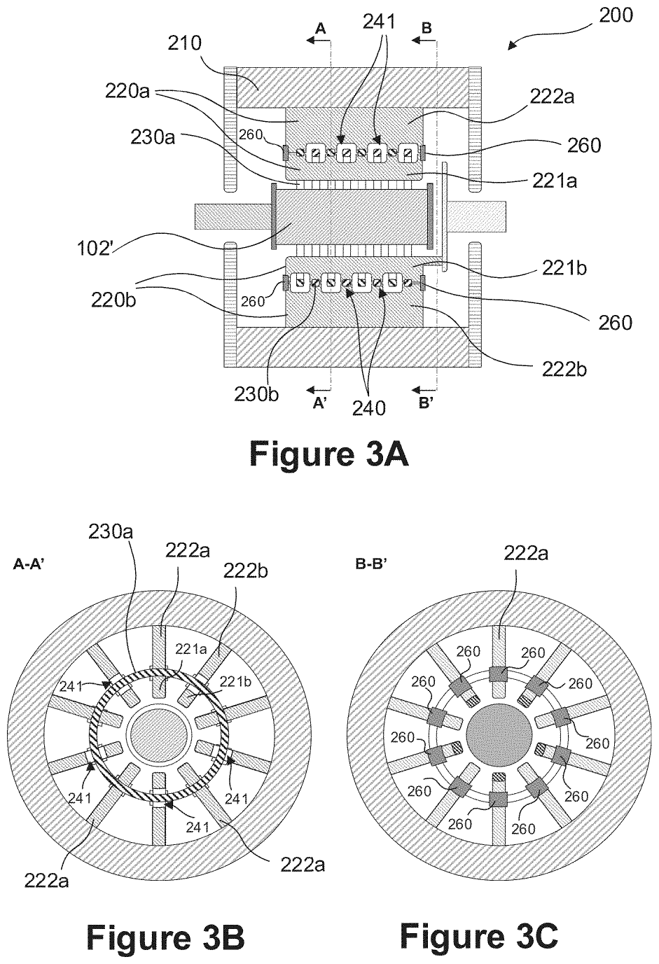

FIG. 2 shows a perspective and exploded view of an anode 200 for a magnetron according to a first example of the disclosure. The anode 200 may be implemented in the magnetron 100 as described in relation to FIGS. 1A and 1B by replacing the anode 101 thereof. FIG. 3A shows a schematic illustration of the anode 200 of FIG. 2 together with a cathode 102′, whilst FIGS. 3B and 3C show schematic cross-sectional views taken along the lines A-A′ and B-B′ of FIG. 3A, respectively. The cathode 102′ may be the cathode 102 described in relation to FIGS. 1A and 1B.

The anode 200 comprises a cylindrical shell 210, a plurality of vanes 220a, 220b, and a plurality of strap rings 230a, 230b. “Cylindrical” as used herein is understood to mean generally/substantially cylindrical. The shell 210 includes a central aperture in which the cathode 102′ may be arranged, as shown in FIG. 3A, and defines a longitudinal axis (up to down in FIG. 2 and left to right in FIG. 3A). The shell 210 may be the anode wall 103 described in relation to FIGS. 1A and 1B, and the strap rings 230a, 230b may be substantially the straps 113 as described in relation to FIGS. 1A and 1B.

The vanes are provided as a first group of vanes 220a and a second group of vanes 220b, each of which are arranged to extend inwardly from the shell 210 and at angular intervals around the shell 210. “Angular intervals” may be understood to mean that an azimuthal separation is provided between each vane and its adjacent vane. The first group of vanes 220a alternates angularly with the second group of vanes 220b, as shown in FIG. 2. The angular separations arising from the intervals between each vane 220a, 220b define an even number of resonant cavities around the shell 210. The strap rings 230a, 230b are arranged at longitudinal intervals and concentrically with the longitudinal axis of the shell 210, and pass through the vanes 220a, 220b, so as to electrically connect alternately arranged vanes, as follows.

Each first vane 220a is provided in two segments, as an inner vane segment 221a and an outer vane segment 222a that are connected together. Likewise, each second vane 220b is provided in two segments, as an inner vane segment 221b and an outer vane segment 222b that are connected together. As shown in FIG. 2, each vane segment 221a, 222a, 221b, 222b is substantially elongate having a length that extends along the longitudinal direction of the shell 210, and having a width extending radially inwardly. The length of each vane segment 221a, 222a, 221b, 222b corresponds to the length of the resonant cavity. Each inner vane segment 221a, 221b faces its respective outer vane segment 221b, 222b along an elongate axis of the vane, such that a longitudinal face of each inner vane segment 221 faces a longitudinal face of its respective outer vane segment 222.

As shown in FIG. 3A, when arranged together, the first inner and outer vane segments 221a, 222a form respective first vanes 220a including a first hole pattern through which the plurality of strap rings 230a, 230b pass. The first hole pattern includes a plurality of first holes 240 and second holes 241 that alternate with one another down the length of the first vanes 220a. The first holes 240 are dimensioned to have a cross-sectional shape approximately the same as the cross-sectional shape of the strap ring. As such, the strap rings are arranged to pass through the first holes 240 and contact the respective vane as they pass therethrough. The second holes 241 however have larger cross-sectional shapes than the cross-sectional shape of the strap ring passing therethrough, such that the strap rings are arranged to pass through the second holes 241 without contacting the respective vane as they pass therethrough. In the specific example of FIG. 3A, the magnetron operates to generate microwaves having frequencies in the S-band (about 2 to 4 GHz), and the first holes 240 may have a diameter in the range of approximately 2.5 mm to 4 mm, whilst the second holes 241 may have a diameter in the range of approximately 5 mm to 10 mm. In the first example of the disclosure, as shown in FIG. 3A, the first and second holes 240, 241 have substantially square shaped profiles to match the square shaped profile of the corresponding strap rings 230a, 230b. Of course, it will be understood that the shape and size of the holes is not limited to the above, but will rather be determined by the dimensions of the corresponding strap ring passing therethrough and the design, frequency range and/or power of the magnetron.

Each first vane 220a is provided with the same first hole pattern, such that the first holes 240 of the first vanes 220a are angularly aligned with one another, and the second holes 241 of the first vanes 220a are angularly aligned with one another. As such, strap rings 230a pass through angularly aligned first holes 240 of the first vanes 220a to electrically connect the first vanes 220a, whilst strap rings 230b passing through angularly aligned second holes 241 of the first vanes 220a do not electrically connect the first vanes 220a.

Similarly, the second inner and outer vane segments 221b, 222b form respective second vanes 220b including a second hole pattern through which the plurality of strap rings 230a, 230b pass. The second hole pattern also includes the first holes 240 and the second holes 241 that alternate with one another down the length of the second vanes 220b. Each second vane 220b is provided with the same second hole pattern, such that the first holes 240 of the second vanes 220b are angularly aligned with one another, and the second holes 241 of the second vanes 220b are angularly aligned with one another. As such, strap rings 230b pass through angularly aligned first holes 240 of the second vanes 220b to electrically connect the second vanes 230b, whilst strap rings 230a passing through angularly aligned second holes 241 of the second vanes 220b do not electrically connect the second vanes 230b.

However, the second hole pattern differs from the first hole pattern in that the first holes 240 of the second vanes 220b are angularly aligned with the second holes 241 of the first vanes 220a, and the second holes 241 of the second vanes 220b are angularly aligned with the first holes 240 of the first vanes 220a, as shown in FIG. 3A. Accordingly, the strap rings may be considered as being provided in two groups including first strap rings 230a and second strap rings 230b that alternate longitudinally with one another, whereby the first strap rings 230a electrically connect first vanes 220a and the second strap rings 230b electrically connect second vanes 220b.

The first and second hole patterns are defined by groove patterns in the longitudinal faces of the inner and outer vane segments 221a, 221b, 222a, 222b. More particularly, as shown in FIG. 2, each inner vane segment 221a, 221b includes a groove pattern in its longitudinal face that faces its respective outer vane segment 222a, 222b. Likewise, each outer vane segment 222a, 222b includes a matching groove pattern in its longitudinal face that faces its respective outer vane segment 221a, 221a. When arranged together to face one another, as shown in FIG. 3A, each first inner and outer vane segment 221a, 222a together form a respective first vane 220a including the first hole pattern, as defined by the groove pattern in the respective longitudinal faces of the first inner and outer vane segments 221a, 222a.

In the first example of the disclosure, the groove patterns form a substantially castellated profile on the longitudinal faces of the respective vane segments. As shown in FIG. 2, the groove patterns include alternating grooves 251 and protrusions, whereby each protrusion defines a recess 250 that is smaller than the groove 251. The recesses 250 have profiles arranged to form the first holes 240, and the grooves 251 have profiles arranged to form the second holes 241, when each inner vane segment 221a, 221b faces its respective outer vane segment 222a, 222b. In other examples, the groove patterns need not include recesses 250 in the protrusions. For example, the protrusions may include a substantially flat longitudinal surface for contacting a strap ring.

As shown in FIGS. 2 and 3A, the groove pattern on each inner vane segment 221a, 221b is symmetrical with the groove pattern on its outer vane segment 222a, 222b, such that the inner and outer vane segments are joined at an axis passing through the holes 240, 241. In the first example of the disclosure, the recesses 250 and grooves 251 are substantially C-shaped or U-shaped as shown in FIG. 3A in order to provide the first holes 240 and second holes 241, respectively.

However, the disclosure is not limited to this, and the first and second hole patterns may be defined by any suitable groove pattern. In some examples of the disclosure, the inner and outer vane segments may not have symmetrical groove patterns. For example, just one of the inner or outer vane segments may include a groove pattern, whilst the other of the inner or outer vane segments may have a substantially smooth profile, such that the groove pattern on the one of the inner or outer vane segments when arranged with the other of the inner and outer vane segments suffices to form the first and second holes.

In the first example of the disclosure, each inner vane segment 221a, 221b is integrally formed and includes another longitudinal face oppositely facing from the longitudinal face that is defined by the groove pattern. The another longitudinal face is arranged to face inwardly toward the cathode 102′. As shown in FIGS. 2 and 3A, the another longitudinal face of each inner vane segment 221a, 221b is substantially smooth and flat along the length of the respective inner vane segment.

In the first example of the disclosure, each outer vane segment 222a, 222b is integrally formed and includes another longitudinal face oppositely facing from the longitudinal face that is defined by the groove pattern. The another longitudinal face is arranged to connect to the shell 210. As shown in FIGS. 2 and 3A, the another longitudinal face of each outer vane segment 222a, 222b is substantially smooth and flat along the length of the respective outer vane segment. In doing so, this can facilitate in brazing the outer vane segments 222a, 222b to the shell 210 more efficiently. As can be seen, for example, in FIG. 3A the inner 221a, 221b and outer 222a, 222b vane segments may be arranged such that they are not in direct physical contact with each other. For example, a gap is provided between an inner vane segment 221a, 221b and its respective outer vane segment 222a, 222b such that there is no direct physical contact between the inner vane segment 221a, 221b and its respective outer vane segment 222a, 222b.

Each inner vane segment 221a, 221b is electrically connected to its respective outer vane segment 222a, 222b. In at least some examples, each inner 221a, 221b and outer 222a, 222b vane segment may be arranged in direct contact with the same strap rings 230a, 230b. For example, can be seen in FIG. 3A, the inner 221a and outer 222a vane segments which form the first vanes 220a may both be in contact with the strap rings labelled 230a. The inner 221b and outer 222b vane segments which form the second vanes 220b may both be in contact with the strap rings labelled 230b. The strap rings 230 thereby provide mechanical and electrical connection between the respective inner and outer vane segments which may not be in direct physical contact with each other.

In the first example of the disclosure, the additional or alternative connection between respective vane segments is performed using a plurality of tags 260, whereby each tag 260 is provided at the longitudinal ends of each respective vane 220a, 220b to connect the respective inner and outer vane segments 221a, 221b, 222a, 222b together. The tags 260 may be electrically conductive components. For example, the tags 250 may be metallic components, such as copper ends, arranged to provide an electrical connection between the inner and outer vane segments.

Providing each vane in two elongate segments as the inner and outer vane segments 221a, 221b, 222a, 222b as in the first example of the disclosure means that the strap rings are sufficiently supported between the inner and outer vane segments. In doing so, the strap rings 230a, 230b pass through the vanes 220a, 220b, so as to be enclosed by the vanes and are only exposed in the resonant cavities. This improves the stability of the magnetron, as compared with magnetrons of the prior art having strap rings that are exposed at either end of anode vanes.

Furthermore, not only are the strap rings 230a, 230b sufficiently and stably supported by the respective vanes 220a, 220b by being arranged between the respective inner and outer vane segments, the anode 200 is provided with more flexibility in the design of the straps 230a, 230b and their arrangement with respect to the vanes 220a, 220b. This means that the mode separation and RF field distribution trade off can be met more easily by a suitable strap design, as compared with magnetrons of the prior art.

Moreover, the anode 200 facilitates further magnetron performance improvement. This is because the inner vane segments 221a, 221b facing the cathode offer a solid and continuous profile. By providing such a continuous profile, no gaps are provided along the longitudinal profile of the vane surface which faces the cathode, thus leading to lower RF losses and a smoother RF field distribution as compared with the prior art. Such a continuous profile without any gaps may therefore increase the power output.

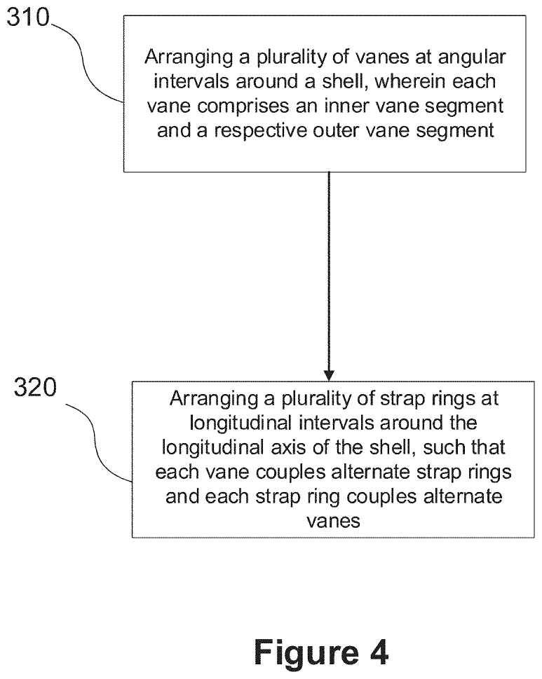

FIG. 4 shows a flow chart of a first example of a method for manufacturing an anode of a magnetron, and may be used to manufacture the anode of the first example of the disclosure.

The method includes steps of providing a generally cylindrical shell, a plurality of vanes and a plurality of strap rings, each of which may be substantially the shell 210, the vanes 220a, 220b and the strap rings 230a, 230b as described in relation to the first example of the disclosure. In particular, the first vanes are provided as pairs of inner and outer vane segments, and the second vanes are provided as pairs of inner and outer vane segments. In step 310, the vanes are assembled at angular intervals around the shell with the first vanes alternating the second vanes, whereby an angular separation between each vane and its adjacent vane is for providing a cavity resonator. In step 320, the strap rings are arranged at longitudinal intervals and concentrically around the longitudinal axis of the shell, such that the first strap rings electrically connect the first vanes, and the second strap rings electrically connect the second vanes. Each inner vane segment is connected to its respective outer vane segment. In the first example of the method, a plurality of tags are used to connect the respective vane segments together. The tags may be substantially provide as the tags 260 described above in relation to the first example of the disclosure.

More particularly, each vane may be provided as its respective inner and outer vane segments 221a, 221b, 222a, 222b, as shown in FIG. 2. In the first example of the method, the vanes are manufactured, although it will be understood that in other examples of the disclosure, the vanes may be provided readymade. The vanes are manufactured as follows in the first example of the disclosure.

Firstly, a plurality of metal cuboids are provided for forming the plurality of vanes. Each cuboid may be shaped, for example by cutting, to have a length and width corresponding to the desired length and width of the resulting vane. The plurality of cuboids are then divided in half to provide a first group of cuboids and a second group of cuboids, each having the same number of cuboids.

In the first example of the method, a first hole pattern is formed through a depth of the first group of cuboids. Any suitable hole forming tool may be implemented to form the holes through the cuboids, for example by milling. The first hole pattern corresponds to the first hole pattern including the arrangement of the first holes 240 and second holes 241 described in relation to the first example of the disclosure, whereby the first and second holes 240, 241 alternate down the length of the vanes. Next, the first cuboids having the first hole pattern are cut lengthways through the first hole pattern, so as to form the inner vane segment 221a and its respective outer vane segment 222a. Any suitable cutting tool may be used. In the first example of the method, the first cuboids are cut midway through the first hole pattern, so as to provide the inner and outer vane segments 221a, 222a with symmetrical groove patterns. In doing so, the inner and outer vane segments 221a, 222a are formed of the same material. Of course, in other examples of the disclosure where the inner and outer vane segments do not have symmetrical groove patterns, the cutting may be determined as required, for example to pass at one side of the first hole pattern, so as to define a groove pattern on the longitudinal face of either the inner vane segment or the outer vane segment, rather than both.

Similarly, a second hole pattern is formed through a depth of the second group of cuboids. The second hole pattern corresponds to the second hole pattern including the arrangement of the first holes 240 and second holes 241 described in relation to the first example of the disclosure, whereby the first and second holes 240, 241 alternate down the length of the vanes, with the first holes 240 of the second vanes 220b being angularly aligned with the second holes 241 of the first vanes 220a, and the first holes 240 of the first vanes 220a being angularly aligned with the second holes 241 of the second vanes 220b. Next, the second cuboids which now include the second hole pattern are cut lengthways through the second hole pattern, so as to form the inner vane segment 221b and its respective outer vane segment 222b.

Forming the vanes 220a, 220b in this manner is both efficient and low-cost, especially when compared with prior art manufacturing methods that form castellated profiles and form vanes from a plurality of segments. In particular, the vanes according to the first example of the method advantageously are integrally formed, whereby each inner vane segment is formed from the same cuboid block as its respective outer vane segment, thereby simplifying the manufacturing process, by eliminating complex cutting and shaping. However, the vanes may be formed by any other suitable method, such as by additive manufacturing techniques.

Examples have been described herein in which the respective inner 221a, 221b and outer 222a 222b, vane segments are formed of the same material. However, in some examples, a respective inner 221a, 221b and outer 222a 222b, vane segment may be formed of different materials.

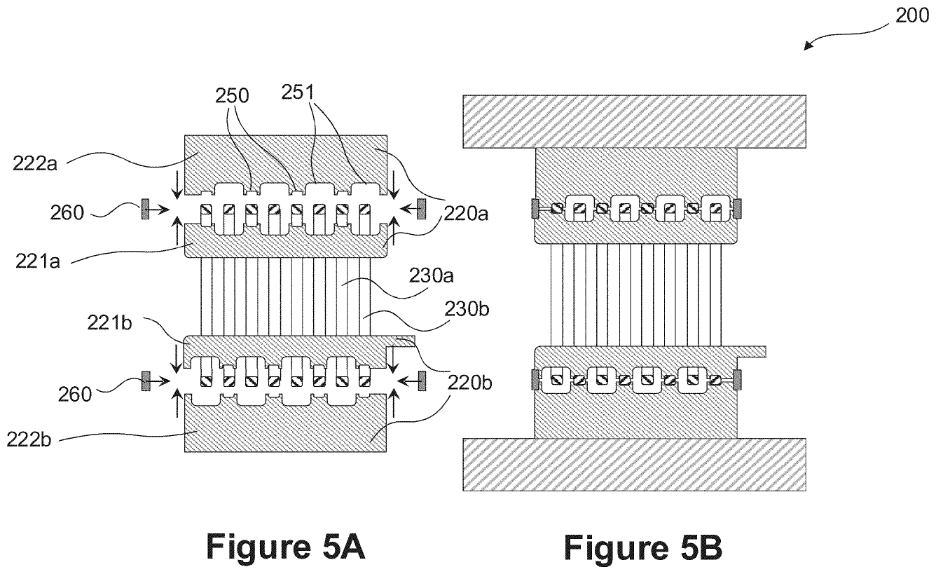

For illustrative purposes, FIGS. 5A and 5B show the inner vane segments 221a, 221b being arranged together with the respective outer vane segments 222a, 222b around respective strap rings 230a, 230b that pass therebetween. Moreover, tags 260 are arranged at the longitudinal ends of each vane 220a, 220b for connecting the respective inner and outer vane segments to one another. As can be seen from FIG. 5B, the inner and outer vane segments 221a, 221b, 222a, 222b are not in direct contact with one another so as to provide a gap therebetween, with the tags 260 electrically connecting the inner and outer vane segments 221a, 221b, 222a, 222b together. As was explained above, further electrical and mechanical connection between the respective inner 221a, 221b and outer 222a, 222b vane segments may be provided by virtue of their contact with the same strap rings 230.

In the first example of the method, the method also comprises forming a plurality of grooves (not shown) on an inner wall of the shell 210, whereby each groove has a width corresponding to the width of each outer vane segment 222a, 222b. The length of each groove may correspond to or may be greater than the length of each outer vane segment 222a, 222b so as to allow the outer vane segments 222a, 222b to be slid into the grooves during assembly. The grooves on the inner wall of the shell 210 are arranged at angular intervals corresponding to the arrangement of the vanes 220a, 220b. Any suitable groove forming tool may be used. In doing so, the grooves are arranged to seat the outer vanes 222a, 222b. Providing the grooves in the inner wall of the shell 210 may serve to indicate where the outer vane segments 222a, 222b should be arranged.

However, the disclosure is not limited to this, and in other examples of the disclosure, the shell 210 includes no grooves defined on its inner wall, and that the outer vane segments 222a, 222b may be adjoined to the inner wall of the shell 210 in the absence of the grooves in the inner wall of the shell 210. This is feasible since the outer vane segments 222a, 222b include the another longitudinal surface that is smoothened so as to be substantially flat for brazing onto the inner wall of the shell 210, even in the absence of grooves thereon.

In the first example of the method, a jig is used to assemble the strap rings with the outer vane segments. More particularly, the first strap rings 230a are arranged in the recesses 250 formed in the groove pattern of the first outer vane segments 222a and are separated from the grooves 251 formed in the groove pattern of the second outer vane segments 222b. The second strap rings 230b are arranged in the recesses 250 formed in the groove pattern of the second outer vane segments 222b and are separated from the grooves 251 formed in the groove pattern of the first outer vane segments 222a. Using a jig allows for efficient placement of the components.

Next, the shell 210 is assembled with the outer vane segments 222a, 222b and the straps 230a, 230b. The inner vane segments 221a, 221b are then arranged with the respective outer vane segments 222a, 222b and the tags 260 are added to the longitudinal ends of the vanes 220a, 220b to electrically connect them. Now that the constituent components of the anode 200 are assembled together, the assembled anode 200 is brazed at a suitable temperature, to solder the inner vane segments 221a, 221b, the respective outer vane segments 222a, 222b, the strap rings 230a, 230b, the shell 120 and the tags 260 together. This makes for a low-cost and efficient method for manufacturing the anode. However, the disclosure is not limited to this, and it will be understood that any suitable method for assembling the anode may be used.

The anode 200 may then be assembled in a magnetron. For example, the anode 200 may be assembled to replace the anode 101 in the magnetron 100.

There is provided herein an anode (200) for a magnetron, the anode comprising: a cylindrical shell (210) defining a longitudinal axis, a centre of the shell for accommodating a cathode (102′) of the magnetron; a plurality of vanes (220a, 220b) arranged at angular intervals around the shell, wherein an angular separation between each vane and its adjacent vane is configured to provide a cavity resonator of the magnetron, wherein each vane has a width extending radially inwardly from the shell toward the centre of the shell, and has a length continuously extending longitudinally in parallel with the longitudinal axis of the shell; and a plurality of annular strap rings (230a, 230b) for setting a resonant mode spectrum of the cavity resonator, wherein the strap rings are arranged at longitudinal intervals and concentrically with the longitudinal axis of the shell, wherein each vane comprises an inner vane segment (221a, 221b) arranged to face the cathode and a respective outer vane segment (222a, 222b) connected to the inner vane segment and interposed between the inner vane segment and the shell, and wherein the plurality of vanes are configured to support the plurality of strap rings between the respective inner and outer vane segments such that each vane couples alternate strap rings and each strap ring couples alternate vanes.

Variations of the described embodiments are envisaged. For example, all of the features disclosed in this specification (including any accompanying claims, abstract and drawings), and/or all of the steps of any method or process so disclosed, may be combined in any combination, except combinations where at least some of such features and/or steps are mutually exclusive.

References herein to radio frequencies may be taken to mean any frequency between about 30 Hz and 300 GHz. Radio frequencies are expressly intended to include microwave frequencies. References herein to microwave frequencies may be taken to mean any frequency between about 300 MHz and 300 GHz.

Examples of magnetrons contemplates herein may be operable to generate microwaves having frequencies in the S band (about 2 to 4 GHz), the C band (about 4 to 8 GHz) and/or the X Band (about 8 to 12 GHz). In some examples, a magnetron may be operable to generate microwaves having frequencies greater than about 3 GHz. The magnetron may be operable to generate microwaves having frequencies of less than about 12 GHz.

All ranges and values (e.g. values and/or ranges of power and/or frequency) provided herein are provided for illustrative purposes only and should not be interpreted to have any limiting effect.

Features, integers or characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An anode for a magnetron, the anode comprising:
a cylindrical shell defining a longitudinal axis, a centre of the shell for accommodating a cathode of the magnetron;
a plurality of vanes arranged at angular intervals around the shell, wherein an angular separation between each vane and its adjacent vane is configured to provide a cavity resonator of the magnetron, wherein each vane has a width extending radially inwardly from the shell toward the centre of the shell, and has a length continuously extending longitudinally in parallel with the longitudinal axis of the shell; and
a plurality of annular strap rings for setting a resonant mode spectrum of the cavity resonator, wherein the strap rings are arranged at longitudinal intervals and concentrically with the longitudinal axis of the shell,
wherein each vane comprises an inner vane segment arranged to face the cathode and a respective outer vane segment connected to the inner vane segment and interposed between the inner vane segment and the shell, and
wherein the plurality of vanes are configured to support the plurality of strap rings between the respective inner and outer vane segments such that each vane couples alternate strap rings and each strap ring couples alternate vanes.

2. The anode of claim 1, wherein each alternate vane is arranged to support the same strap ring, so as to be electrically connected by the same strap ring.

3. The anode of claim 1, wherein the inner vane segments are integrally formed.

4. The anode of claim 1, wherein the outer vane segments are integrally formed.

5. The anode of claim 1, wherein the plurality of vanes includes a plurality of holes defined through a depth of the vanes, the holes for the strap rings to pass therethrough, wherein the plurality of holes include first holes and second holes,
wherein the first holes are for the vanes to couple with strap rings passing therethrough, wherein each first hole has a cross-sectional area dimensioned to a cross-sectional area of the respective strap ring passing therethrough,
wherein the second holes are dimensioned to be bigger than the cross-sectional area of a strap ring passing through the second hole, such that, in use, the respective vane is not configured to couple with the strap ring arranged in the second hole,
wherein the plurality of vanes includes angularly alternating first vanes and second vanes,
wherein each first vane includes a plurality of the first holes and the second holes that alternate longitudinally along the length of each first vane, as defined by a first groove pattern in a longitudinal surface of at least one of the inner vane segment and outer vane segment that faces its respective vane segment, wherein the first groove pattern of each first vane is angularly aligned with the first groove pattern of the other first vanes,
wherein each second vane includes a plurality of the first holes and the second holes that alternate longitudinally along the length of each second vane, as defined by a second groove pattern in a longitudinal surface of at least one of the inner vane segment and outer vane segment that faces its respective vane segment, wherein the second groove pattern of each second vane is angularly aligned with the second groove pattern of the other second vanes, and
wherein the first holes of the second vanes are angularly aligned with the second holes of the first vanes, and wherein the first holes of the first vanes are angularly aligned with the second holes of the second vanes.

6. The anode of claim 5, wherein each of the first and second groove patterns include alternating grooves and protrusions forming a castellated profile in each vane segment, wherein each protrusion defines a recess that is smaller than the groove, wherein the grooves of the groove pattern define at least half the cross-sectional profile of the second holes and the recesses of the protrusions define at least half the cross-sectional profile of the first holes.

7. The anode of claim 5, wherein each inner vane segment has another longitudinal surface opposite the longitudinal surface defined by one of the first and second groove patterns, wherein the another longitudinal surface is flat having a smooth profile.

8. The anode of claim 5, wherein each outer vane segment has another longitudinal surface opposite the longitudinal surface defined by one of the first and second groove patterns, wherein the another longitudinal surface is attached to an inner surface of the shell.

9. The anode of claim 1, wherein the inner surface of the shell includes a plurality of grooves extending longitudinally down the length of the shell and arranged angularly at intervals, each groove being dimensioned to seat a respective outer vane segment.

10. The anode of claim 1, wherein the inner and outer vane segments are arranged such that a gap is provided between the inner vane segments and their respective outer vane segments.

11. The anode of claim 1, further comprising at least one tag for connecting each inner vane segment to its respective outer vane segment, wherein the at least one tag is arranged at a longitudinal end of the respective vane.

12. The anode of claim 1, wherein the inner and outer vane segments are formed of the same material.

13. A vane for an anode of a magnetron, the vane as defined in claim 1.

14. A magnetron comprising an anode as defined in claim 1.

15. A method of manufacturing an anode for a magnetron, the method comprising:
providing a cylindrical shell defining a longitudinal axis, a centre of the shell for accommodating a cathode of the magnetron;
providing a plurality of vanes, wherein each vane has a width for extending radially inwardly from the shell toward the centre of the shell, and has a length for continuously extending longitudinally in parallel with the longitudinal axis of the shell;
providing a plurality of annular strap rings for setting a resonant mode spectrum of a cavity resonator of the magnetron; and
arranging the vanes and strap rings in the shell, such that:
the vanes are arranged at angular intervals around the shell, wherein an angular separation between each vane and its adjacent vane is for providing the cavity resonator of the magnetron,
the strap rings are arranged at longitudinal intervals and concentrically with the longitudinal axis of the shell,
wherein each vane comprises an inner vane segment arranged to face the cathode and a respective outer vane segment connected to the inner vane segment and interposed between the inner vane segment and the shell, and
wherein the plurality of vanes are configured to support the plurality of strap rings between the respective inner and outer vane segments such that each vane couples alternate strap rings and each strap ring couples alternate vanes.

16. The method of claim 15, wherein the providing the plurality of vanes comprises forming the plurality of vanes by:
forming a first hole pattern in a first group of metal cuboids through a depth thereof, wherein the first hole pattern includes a plurality of first holes and second holes alternating along the length of each metal cuboid in the first group, wherein each first hole has a cross-sectional area dimensioned to the cross-sectional area of a strap ring for a magnetron, and wherein each second hole has a cross-sectional area dimensioned to be greater than the cross-sectional area of the strap ring, such that the strap ring can pass through the second hole without contacting the metal block;
forming a second hole pattern in a second group of metal cuboids through a depth thereof, wherein the second hole pattern includes a plurality of the first holes and the second holes alternating along the length of each metal cuboid in the second group, wherein when the first group and the second group of the milled cuboids are angularly arranged around the shell, the first holes of the first group are aligned with the second holes of the second group, and the second holes of the first group are aligned with the first holes of the second group; and
cutting each metal cuboid lengthways into two elongate segments to provide a vane including an inner vane segment and a respective outer vane segment, the cutting being through the first and second holes to define a groove pattern on a longitudinal surface of at least one of the inner vane segment and the outer vane segment,
wherein the plurality of vanes is arranged around the shell such that:
the vanes of the first group alternate with the vanes of the second group,
the first and second holes are angularly aligned for each alternate vane segment,
the first holes of the first group are angularly aligned with the second holes of the second group, and
the second holes of the first group are angularly aligned with the first holes of the second group.

17. The method of claim 16, further comprising arranging the strap rings between the inner and outer vane segments in respective first holes for electrically connecting alternate vanes.

18. The method of any claim 15, further comprising arranging the inner and outer vane segments such that a gap is provided between the inner vane segments and their respective outer vane segments.

19. The method of claim 15, further comprising electrically connecting each outer vane segment to its respective inner vane segment using at least one tag arranged at an end of the vane for bridging the gap between the inner and outer vane segments.

20. The method of claim 15, wherein providing the shell comprises providing a metallic cylinder and forming an even number of elongate grooves in an inner wall of the cylinder at angular intervals for seating the outer vanes.
